(19) United States
(12) Patent Application Publication
(10) Pub. No.: US 2024/0123796 A1
(43) Pub. Date: Apr. 18, 2024

(54) DUAL COOLING WATER HEATER

(71) Applicant: Hanon Systems, Daejeon (KR)

(72) Inventors: Hyun Seok JUNG, Daejeon (KR); Cha You LIM, Daejeon (KR)

(21) Appl. No.: 18/277,093

(22) PCT Filed: Mar. 24, 2022
(86) PCT No.: PCT/KR2022/004121

§ 371 Date: Aug. 14, 2023

(30) Foreign Application Priority Data
May 6, 2021 (KR) 10-2021-0058443

(51) Int. Cl. B60H 1/00

(52) U.S. Cl. CPC B60H 1/00885; B60H 2001/00928

(57) ABSTRACT

The present disclosure provides a dual cooling water heater including a main body on which a substrate is seated, a flow path forming part connected to the main body and having first and second flow paths provided on one surface thereof, a first heating element disposed on the other surface of the flow path forming part and configured to heat the first flow path, a second heating element disposed on the other surface of the flow path forming part and configured to heat the second flow path, and a control unit configured to control a temperature and a flow rate of cooling water moving through the first flow path and a temperature and a flow rate of cooling water moving through the second flow path by controlling a temperature of the first heating element and a temperature of the second heating element.

### TECHNICAL FIELD

Embodiments relate to a dual cooling water heater. More specifically, embodiments relate to a dual cooling water heater, in which two cooling water flow paths are formed in the single cooling water heater, and temperatures of cooling water moving along the flow paths are controlled.

### BACKGROUND ART

Recently, most common vehicles have used engines as driving sources. The engines use gasoline, light oil, and the like as energy sources. However, the use of these energy sources causes various problems, such as environmental pollution and depleting petroleum reserves. Therefore, there is a gradually increasing need for new energy sources, and vehicles such as electric vehicles, which use new energy sources, are being developed or practicalized.

However, the electric vehicle does not have a heat source such as an engine that generates a large amount of heat. Therefore, a heat source, which is to be used for an air conditioning device for a vehicle, needs to be additionally installed.

Examples of the heat source additionally installed in the electric vehicle or the like in the related art includes a heat pump, an electric heater, and the like. Among them, the electric heater is widely used because the electric heater may be used without greatly changing the design of the air conditioning device in the related art.

The electric heaters are broadly classified into an air-heating heater configured to directly heat air to be blown into an interior of a vehicle, and a fluid-heating heater (or cooling water heater) configured to indirectly heat air by heating cooling water that exchanges heat with the air.

In the related art, a flow path for the cooling water heater is changed to supply the cooling water to heat an occupant compartment or raise a temperature of a battery.

However, a battery module is a component sensitive to a temperature. For this reason, there is concern that a high water temperature adversely affects the lifespan and efficiency of the battery in case that a temperature of the cooling water is raised to heat the interior in a configuration in which a battery cooling line and an interior heating line are integrated.

### DISCLOSURE

### Technical Problem

An object of an embodiment is to supply cooling water to heat both a battery and an interior to different target temperatures by using a single cooling water heater.

Objectives to be solved by the present invention are not limited to the above-described objectives, and other objectives, which are not described above, will be clearly understood by those skilled in the art from the following description.

### Technical Solution

An embodiment of the present invention provides a dual cooling water heater including: a main body on which a substrate is seated; a flow path forming part connected to the main body and having first and second flow paths provided on one surface thereof; a first heating element disposed on the other surface of the flow path forming part and configured to heat the first flow path; a second heating element disposed on the other surface of the flow path forming part and configured to heat the second flow path; and a control unit configured to control a temperature and a flow rate of cooling water moving through the first flow path and a temperature and a flow rate of cooling water moving through the second flow path by controlling a temperature of the first heating element and a temperature of the second heating element.

In particular, the first and second flow paths may each have a curved portion and a straight portion.

In particular, the first flow path may supply the cooling water for heating a battery, and the second flow path may supply the cooling water for heating an interior.

In particular, the first and second flow paths may be separated by a partition wall.

In particular, the first flow path may include a first inlet port and a first outlet port, a temperature sensor is disposed at one side of the first outlet port, and the control unit stops an operation of the first heating element when a temperature value detected by the temperature sensor exceeds a preset temperature.

In particular, the first outlet port may be disposed to be farther from the partition wall than the first inlet port from the partition wall.

In particular, a thermal insulator may be disposed in the partition wall.

In particular, the partition wall may have an air gap.

In particular, the second flow path may include a second inlet port and a second outlet port.

In particular, the first inlet port and the first outlet port may be disposed in a direction opposite to a direction in which the second inlet port and the second outlet port are disposed.

In particular, the first inlet port and the second inlet port may be disposed to be closer to the partition wall than the second outlet port and the second outlet port to the partition wall.

### Advantageous Effects

According to the embodiment, it is possible to supply the cooling water to heat both the battery and the interior to different target temperatures.

In addition, it is possible to supply the cooling water at different flow rates.

In addition, the cooling water heaters are integrated into the single cooling water heater in the heat pump system, which may improve the spatial efficiency and reduce the weight.

In addition, the integrated thermal management system may supply the cooling water with an appropriate temperature to the battery by using the single heater, thereby improving the efficiency and lifespan of the battery.

Various useful advantages and effects of the present invention are not limited to the above-described contents and will be more easily understood from descriptions of the specific embodiments.

### BRIEF DESCRIPTION OF THE DRAWINGS

FIG. 1 is a view illustrating a system structure of a dual cooling water heater according to an embodiment of the present disclosure.

FIG. 2 is a perspective view of the dual cooling water heater illustrated in FIG. 1.

FIG. 3 is an exploded perspective view of FIG. 2.

FIG. 4 is a view illustrating a structure in which heating elements are disposed below flow paths in FIG. 3.

FIG. 5 is a view illustrating a first embodiment of a flow path structure illustrated in FIG. 3.

FIG. 6 is a view illustrating a second embodiment of the flow path structure illustrated in FIG. 3.

### MODE FOR INVENTION

Hereinafter, exemplary embodiments of the present invention will be described in detail with reference to the accompanying drawings.

However, the technical spirit of the present invention is not limited to some embodiments which will be described and may be realized using various other embodiments, and at least one component of the embodiments may be selectively coupled, substituted, and used to realize the technical spirit within the range of the technical spirit.

In addition, unless clearly and specifically defined otherwise by context, all terms (including technical and scientific terms) used herein can be interpreted as having customary meanings to those skilled in the art, and meanings of generally used terms, such as those defined in commonly used dictionaries, will be interpreted by considering contextual meanings of the related technology.

In addition, the terms used in the embodiments of the present invention are considered in a descriptive sense and not for limiting the present invention.

In the present specification, unless clearly indicated otherwise by the context, singular forms include the plural forms thereof, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” can be used.

The terms are only to distinguish one element from another element, and an essence, order, and the like of the element are not limited by the terms.

In addition, it should be understood that, when an element is referred to as being “connected or coupled” to another element, such a description may include both of a case in which the element is directly connected or coupled to another element and a case in which the element is connected or coupled to another element with still another element disposed therebetween.

In addition, in a case in which any one element is described as being formed or disposed “on or under” another element, such a description includes both a case in which the two elements are formed or disposed in direct contact with each other and a case in which one or more other elements are interposed between the two elements. In addition, when one element is described as being disposed “on or under” another element, such a description may include a case in which the one element is disposed at an upper side or a lower side with respect to another element.

Hereinafter, example embodiments of the invention will be described in detail with reference to the accompanying drawings. Components that are the same or correspond to each other will be denoted by the same reference numerals regardless of the figure numbers, and redundant descriptions will be omitted.

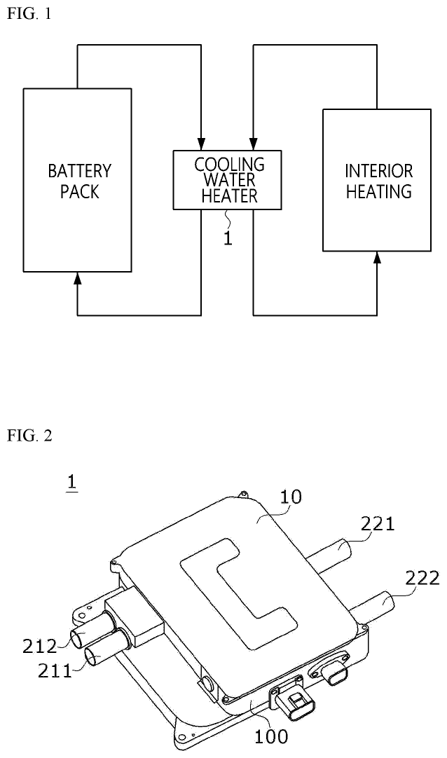

FIGS. 1 to 6 clearly illustrate only main features for conceptually and clearly understanding the present invention. As a result, various modifications of the drawings are expected, and the scope of the present invention need not be limited to particular shapes illustrated in the drawings.

FIG. 1 is a view illustrating a system structure of a dual cooling water heater according to an embodiment of the present disclosure.

With reference to FIG. 1, a dual cooling water heater 1 according to an embodiment of the present disclosure is configured such that two cooling water flow paths are disposed in the single cooling water heater, and the flow paths are controlled to provide different temperatures or flow rates.

Cooling water for heating a battery moves through a first flow path 210, and cooling water for heating an interior of a vehicle moves through a second flow path 220. In this case, the cooling water may be referred to as a heat exchange medium.

A temperature of the cooling water for heating the interior and a temperature of the temperature of the cooling water for heating the battery may be independently controlled by the structure, such that the battery, which is sensitive to a temperature, may be efficiently managed.

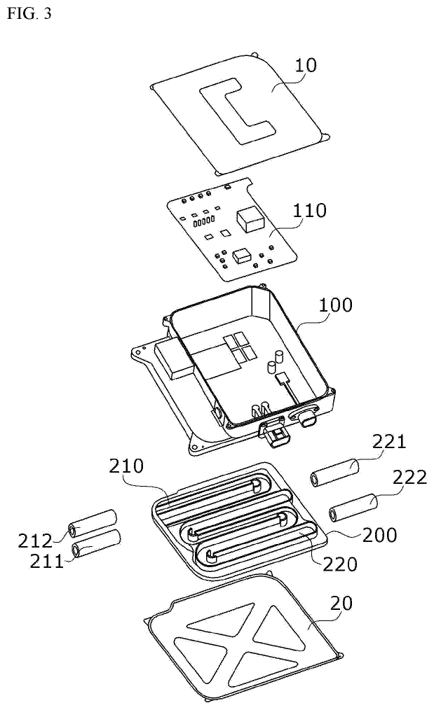

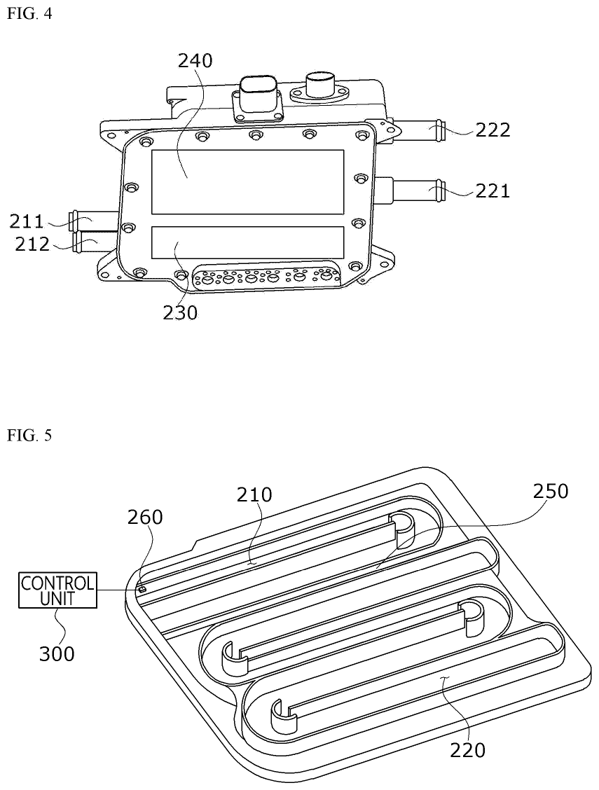

FIG. 2 is a perspective view of the dual cooling water heater illustrated in FIG. 1, FIG. 3 is an exploded perspective view of FIG. 2, and FIG. 4 is a view illustrating a structure in which heating elements are disposed below flow paths in FIG. 3.

With reference to FIGS. 2 to 4, the dual cooling water heater 1 according to the embodiment of the present disclosure may include a first cover 10, a main body 100, a flow path forming part 200, a control unit 300, and a second cover 20.

The first and second covers 10 and 20 may be respectively connected to upper and lower portions of the main body 100 and protect constituent elements connected to the main body 100. The first and second covers 10 and 20 may be variously modified without being limited in shapes.

The main body 100 may include a space in which a substrate 110 is seated. A sealing part, such as an O-ring, may be provided in a coupling region between the main body 100 and the first cover 10, thereby improving watertightness.

The main body 100 may have a bottom and a sidewall. In addition, the main body 100 may be coupled to the first cover 10 to define the space in which the substrate 110 is seated.

The substrate 110 may be disposed inside the sidewall and coupled to the bottom of the main body 100 by means of fastening members such as bolts. Various electronic elements may be disposed in the main body 100, and a connector may be electrically connected to the substrate 110. In this case, the substrate 110 may be a circuit board.

In addition, the substrate 110 may be connected to a heating element through a busbar. Therefore, the heating element and the substrate 110 may be electrically connected.

The flow path forming part 200 may be connected to the other side surface of the main body 100 on which the substrate 110 is seated. The flow path forming part 200 may be electrically connected to the substrate 110. That is, the substrate 110 may be seated on a first surface of the main body 100, and the flow path forming part 200 may be connected to a second surface of the main body 100. In this case, one surface of the main body 100, on which the substrate 110 is seated, may be referred to as the first surface, and a surface opposite to the first surface may be referred to as the second surface.

The flow path forming part 200 may include the first flow path 210 and the second flow path 220. In one embodiment, the flow path forming part 200 may be made of a metallic material to receive heat generated from the heating element, and the flow path forming part 200 may be made of aluminum or stainless steel.

The first and second flow paths 210 and 220 may each include a curved portion and a straight portion, thereby improving the spatial utilization efficiency. The first and second flow paths 210 and 220 may have various arrangements and shapes without being limited in shapes.

In addition, the first and second flow paths 210 and 220 are illustrated as being recessed in the flow path forming part 200 in the drawings. However, the present invention is not limited thereto, and the first and second flow paths 210 and 220 may be variously modified.

A first inlet port 211 and a first outlet port 212 may be connected to the first flow path 210, and a second inlet port 221 and a second outlet port 222 may be connected to the second flow path 220. The first inlet port 211 and the first outlet port 212 may be disposed in the same direction, and the second inlet port 221 and the second outlet port 222 may be disposed in the same direction.

First and second heating elements 230 and 240 may be disposed on the other surface of the flow path forming part 200 on which the first and second flow paths 210 and 220 are formed. For example, the first flow path 210 may be disposed to overlap the first heating element 230. Further, the second flow path 220 may be disposed to overlap the second heating element 240. Therefore, the first heating element 230 may heat the first flow path 210, and the second heating element 240 may heat the second flow path 220. Further, the first and second heating elements 230 and 240 may be controlled by a single control unit 300. In this case, the first and second flow paths 210 and 220 may each be provided in the form of a groove concavely formed in one surface of the flow path forming part 200. Further, the groove may be formed to have a predetermined length.

Meanwhile, as illustrated in FIG. 4, the first and second heating elements 230 and 240 may be disposed to be spaced apart from each other at a predetermined interval. Further, a cooling water temperature in the first inlet port 211 may be lower than a cooling water temperature in the first outlet port 212 by the first heating element 230. In addition, a cooling water temperature in the second inlet port 221 may be lower than a cooling water temperature in the second outlet port 222 by the second heating element 240.

In one embodiment, the first flow path 210 may supply the cooling water for heating the battery, and the second flow path 220 may supply the cooling water for heating the interior of the vehicle.

The control unit 300 may control the temperature and the flow rate of the cooling water moving through the first flow path 210 and the temperature and the flow rate of the cooling water moving through the second flow path 220. The control unit 300 may control the temperature of the cooling water moving along the first flow path 210 and the temperature of the cooling water moving along the second flow path 220 by controlling the operations of the first and second heating elements 230 and 240.

In general, a cooling water temperature of about 80° C. is required to heat the interior, and a cooling water temperature at a room temperature (18 to 25° C.) level is required to heat the battery. In the related art, a cooling water heater having a single flow path is used to heat an interior and a battery, which makes it difficult to supply cooling water with a flow rate and amount of heat that satisfy both the heating of the interior and the heating of the battery. In particular, a method of distributing cooling water by using a separate valve has a problem in that a supply of amount of heat required for a corresponding region is slow, and the fast-acting property deteriorates.

In the present disclosure, the first and second flow paths 210 and 220 may be used to independently heat the battery and the interior. Therefore, in case that different flow rates of the cooling water and different amounts of heat are required to heat the battery and the interior, it is possible to supply the cooling water to satisfy all the regions.

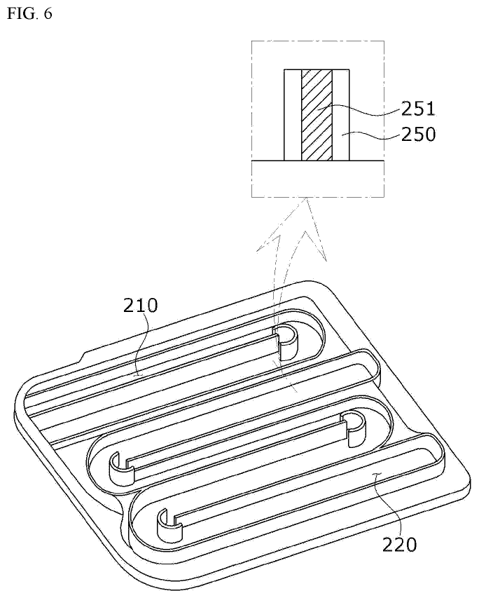

FIG. 5 is a view illustrating a first embodiment of a flow path structure illustrated in FIG. 3.

With reference to FIG. 5, in the flow path forming part 200, the first and second flow paths 210 and 220 are separated by a partition wall 250. That is, the first and second flow paths 210 and 220 may be spaced apart from each other by the partition wall 250. In this case, the flow path forming part 200 is made of a metallic material to receive heat generated from the heating element.

However, the temperature of the cooling water moving through the first flow path 210 and the temperature of the cooling water moving through the second flow path 220 are differently controlled. In this case, the cooling water, which moves along the first flow path 210 to heat the battery, may have a temperature of 18 to 25° C., and the cooling water, which moves along the second flow path 220 to heat the interior, may have a temperature of 80° C.

In the present disclosure, the two flow paths are controlled to have different temperatures. In case that the temperatures of the cooling water are controlled to be different temperatures, thermal conduction may occur through the partition wall 250. In case that the temperature of the cooling water moving through the first flow path 210 is raised by the occurrence of thermal conduction, there may occur a problem in that the battery is damaged. In addition, there may occur a problem in that the cooling water in the second flow path 220, in which a thermal loss occurs, cannot satisfy the requirement to heat the interior of the vehicle.

To solve the problem, a temperature sensor 260 may be disposed at one side of the first outlet port 212 at which the first flow path 210 is disposed. Further, a temperature value detected by the temperature sensor 260 exceeds a preset temperature, the control unit 300 may stop the operation of the first heating element 230.

In one embodiment, in case that a predetermined value of the temperature of the cooling water moving through the first flow path 210 is set to 25° C., there is concern that the battery is damaged when the cooling water with a temperature value higher than the predetermined value flows. Therefore, in case that the temperature sensor 260 detects a temperature of 25° C. or more, the control unit 300 may stop the operation of the first heating element 230.

As illustrated in FIG. 5, the first flow path 210 may have a ‘U’ shape including the straight portion and the curved portion. The first outlet port 212 and the first inlet port 211 are provided at two opposite ends of the first flow path 210.

In this case, the first outlet port 212 may be disposed to be farther from the partition wall 250 than the first inlet port 211 from the partition wall 250. For example, a distance from the partition wall 250 to the first outlet port 212 may be longer than a distance from the partition wall 250 to the first inlet port. The temperature of the cooling water introduced through the first inlet port 211 may be raised by the thermal conduction as the cooling water moves along the partition wall 250. Further, the cooling water may be discharged through the first outlet port 212.

When the temperature sensor 260 is disposed at a side of the first inlet port 211, the temperature of the cooling water is raised as the cooling water moves along the first flow path 210, which causes a problem in which the temperature of the cooling water to be supplied to the battery cannot be accurately measured.

In addition, in case that the first outlet port 212 is disposed adjacent to the partition wall 250, the temperature of the cooling water is raised as the cooling water passes over the partition wall 250, and then the cooling water is discharged. For this reason, there may occur a problem at the time of controlling the temperature of the cooling water moving along the first flow path 210.

To solve the problem, the first outlet port 212 may be disposed to be farther from the partition wall 250 than the first inlet port 211 from the partition wall 250, which makes it possible to stably control the temperature of the cooling water moving through the first flow path 210.

In addition, the second inlet port 221 and the second outlet port 222 may be disposed in the second flow path 220.

In this case, the second inlet port 221 may be disposed to be closer to the partition wall 250 than the second outlet port 222 to the partition wall 250 in order to minimize a degree to which the second flow path 220, through which the cooling water is supplied to heat the interior, affects the first flow path 210. Therefore, it is possible to minimize a degree to which the cooling water, which is finally discharged at a temperature raised as the cooling water passes through the second flow path 220, affects the partition wall 250.

In addition, the first inlet port 211 and the first outlet port 212 may be disposed in a direction opposite to a direction in which the second inlet port 221 and the second outlet port 222 are disposed. In case that a plurality of inlet ports and a plurality of outlet ports are disposed on the same surface, there is concern that an operator erroneously assembles the dual cooling water heater. To solve the above-mentioned problem, in the present disclosure, the first inlet port 211 and the first outlet port 212 of the first flow path 210 and the second inlet port 221 and the second outlet port 222 of the second flow path 220 may be disposed in the different directions and provided on the sides of the flow path forming part 200 that face each other, thereby preventing the above-mentioned problem. For example, the first inlet port 211 and the first outlet port 212 are disposed at one side of the flow path forming part 200, and the second inlet port 221 and the second outlet port 222 are disposed at the other side of the flow path forming part 200. In this case, the first inlet port 211, the first outlet port 212, the second inlet port 221, and the second outlet port 222 may be disposed so that a distance from the first outlet port 212 to the second outlet port 222 is longer than a distance from the first inlet port 211 to the second inlet port 221.

FIG. 6 is a view illustrating a second embodiment of the flow path structure illustrated in FIG. 3.

With reference to FIG. 6, a thermal insulator 251 may be disposed in the partition wall 250. The thermal insulator 251 may be disposed in the partition wall 250 and block the transfer of heat from the cooling water moving through the second flow path 220.

In one embodiment, an air gap may be used as the thermal insulator 251. However, the present invention is not limited thereto, and the thermal insulator 251 may be variously modified and made of various materials.

In case that the air gap is used as the thermal insulator 251, a structure having an internal cavity or trough may be provided, and a thermal insulation structure may be provided during the process of manufacturing the flow path forming part 200, which may reduce the number of separate materials and manufacturing costs.

The embodiment of the present invention has been specifically described above with reference to the accompanying drawings.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

### DESCRIPTION OF REFERENCE NUMERALS

1: Dual cooling water heater, 10: First cover, 20: Second cover, 100: Main body, 110: Substrate, 200: Flow path forming part, 210: First flow path, 211: First inlet port, 212: First outlet port, 220: Second flow path, 221: Second inlet port, 222: Second outlet port, 230: First heating element, 240: Second heating element, 250: Partition wall, 251: Thermal insulator, 260: Temperature sensor, 300: Control unit

What is claimed is:

1. A dual cooling water heater comprising:
a main body on which a substrate is seated;
a flow path forming part connected to the main body and having first and second flow paths provided on one surface thereof;
a first heating element disposed on the other surface of the flow path forming part and configured to heat the first flow path;
a second heating element disposed on the other surface of the flow path forming part and configured to heat the second flow path; and
a control unit configured to control a temperature and a flow rate of cooling water moving through the first flow path and a temperature and a flow rate of cooling water moving through the second flow path by controlling a temperature of the first heating element and a temperature of the second heating element.

2. The dual cooling water heater of claim 1, wherein the first and second flow paths each have a curved portion and a straight portion.

3. The dual cooling water heater of claim 1, wherein the first flow path supplies the cooling water for heating a battery, and the second flow path supplies the cooling water for heating an interior.

4. The dual cooling water heater of claim 3, wherein the first and second flow paths are separated by a partition wall.

5. The dual cooling water heater of claim 4, wherein the first flow path comprises a first inlet port and a first outlet port, a temperature sensor is disposed at one side of the first outlet port, and the control unit stops an operation of the first heating element when a temperature value detected by the temperature sensor exceeds a preset temperature.

6. The dual cooling water heater of claim 5, wherein the first outlet port is disposed to be farther from the partition wall than the first inlet port from the partition wall.

7. The dual cooling water heater of claim 4, wherein a thermal insulator is disposed in the partition wall.

8. The dual cooling water heater of claim 4, wherein the partition wall has an air gap.

9. The dual cooling water heater of claim 5, wherein the second flow path comprises a second inlet port and a second outlet port.

10. The dual cooling water heater of claim 9, wherein the first inlet port and the first outlet port are disposed in a direction opposite to a direction in which the second inlet port and the second outlet port are disposed.

11. The dual cooling water heater of claim 10, wherein the first inlet port and the second inlet port are disposed to be closer to the partition wall than the second outlet port and the second outlet port to the partition wall.
